(19) United States
(12) Patent Application Publication
(10) Pub. No.: US 2008/0065346 A1
(43) Pub. Date: Mar. 13, 2008

(54) System and Method for Measurement of Existing Structures with Known or Assumed to be Known Geometrical Properties

(76) Inventor: Dmitry Shkipin, Fremont, CA (US)

Correspondence Address: DMITRY SHKIPIN, 3566 BEARD RD., FREMONT, CA, 94555, US

(21) Appl. No.: 11/530,424

(22) Filed: Sep. 8, 2006

(51) Int. Cl. G01B 5/24; G01B 5/14; G06F 17/00; G06F 17/50

(52) U.S. Cl. 702/151; 702/159; 703/1; 705/400

(57) ABSTRACT

A measurement system intended for use in the existing structures which comprises of a distance measurement device, an angle measurement device which is capable of measuring angles in two-dimensional or three-dimensional space, and a software interface which is capable of receiving, evaluating recording, transferring and processing measured angles and distances in conjunction with an array of user-defined, programmed, known, or assumed to be known angles and distances. Measurement system is to be used in conjunction with a measurement algorithm which is to be followed by the user. Measurement system records dimensional values between at least two objects within measured space as well as an angular reference between the line of sight of the measurement device and one or more reference axes of the measured space in two-dimensional or three-dimensional space in one or more operations. Measurement system evaluates measured angles and distances in an arrangement with one or more known geometric properties of the measured space, as defined by the user, programmed, known or assumed to be known. Measurement system either displays derived data or transfers data for further use to the estimating software program, CADD software program, or a database for various purposes.

### BACKGROUND OF THE INVENTION

1. Field of the Invention

The present invention relates to field verifications of the existing structures and related trades such as construction, design, drafting, estimating, manufacturing, real estate, inspections, appraisal industry, property management and others.

2. Description of the Related Art

Conventional way of rapid dimensional verifications of the existing structures and man-made objects in general includes dimensional verifications using devices such as a measuring tape and, more recently, laser-based distance measuring devices. Handheld laser-based distance measuring devices became widely available and extensively used in construction, manufacturing, design, building management, real estate and other related industries. Using handheld laser-based distance measuring devices dramatically improves measuring speed over the traditional metric devices as there is no need to pull tape across the measured space. Namely, when measuring dimensions of the existing structure, one person operates the laser-based measurement device by placing it against an object, such as a wall, and directs the device toward another object, such as a building column. A laser-based measurement device interprets the distance and displays the reading on a digital read-out or transfers the reading to a personal computer or personal handheld device for further use. No staking of any kind is usually required, although the device may be mounted on a tri-pod or some other type of support. The current standard of determining basic interior dimensions of the rectangular space, such as an office, include several tasks including taking laser-based measurement device to one of the walls, setting it perpendicular to the wall and parallel to the floor, taking a measurement, removing laser-based measurement device away from the wall and placing it against an adjacent wall in similar manner, taking a measurement perpendicular to the first, removing laser-based measurement device away from the wall, placing it perpendicular to floor and taking floor-to-ceiling height measurement. Measurements can be written down, transferred, read or manipulated by the laser-based distance measuring device for the purpose of obtaining area, volume, perimeter and other data per user preference. To determine area of same measured space, for example, user presses a button on the laser-based distance measuring device which activates an “area” function which, in its turn, enables interface inviting user to use the device to measure width and then measure length of the space in question. Measurement device multiplies the two dimensions to produce area of the space for user's reference. Similar tasks are required to come up with the volume. Other options, such as angle determination, are also available which utilize dimensioning capability of the laser-based measurement device with the conjunction of basic multiplication functions. Recently various software packages became available which are able to interpret device readings and the user is given an option to transfer such reading into a computer aided design and drafting program that uses the reading to build lines and other objects as set by the user. When using such set up, measurements are transferred into a personal computer or a personal handheld device which has a capability of importing the measurement values into CADD software program in order to help user create line-by-line schematic sketch of the measured space. Currently, a simple process of drawing a rectangular box as a representation of the inner walls of the room requires at least four measurements to be taken, one for every wall distance. A user is usually queried after every measurement is imported with regard to the angle reference he or she wants to draft that particular dimension in. Basis for such measurement using a handheld laser device without needing to set stations and staking, as readily used in traditional land-surveying, is founded on the simple fact that most of the structures built today utilize standard angles, ninety degrees being the most common. When the handheld device is used to measure a rectangular office, for example, an assumption user makes is that walls are placed perpendicular to the floor and adjacent walls are perpendicular to one another, making staking set-up, which is usually used in land surveying, needless.

However, current measurement method, user interface options and software available for structure surveying operations fail to fully utilize the fact that most existing structures built today utilize simple square geometry. Currently user is required to perform more operations using a measurement device then needed.

Further, current laser measurement method also renders itself useless if there is an obstacle in the direct line of sight between two objects distance between which is being measured. User is forced to use an alternate direction to take a measurement which avoids an obstacle and away from the shortest line of sight, making measurements approximate and far from accurate.

Further, current method renders itself particularly inefficient when data is transferred from the laser-based measurement device to a computer aided design and drafting software. Currently every line drawn using such software requires at least one dimension to be taken and an angle reference to be inputted by the user. When measuring basic interior dimensions of the rectangular office, for example, user is forced to spend a significant amount of time positioning lines while taking measurement of every one of the 4 walls.

Further, current method is difficult to apply when doing estimating and field take-off functions or assigning building data into the spreadsheet database for any purpose. In order to calculate the area of the walls in a rectangular office, for example, the user is required to obtain several dimensions including perimeter of all the walls and wall height separately, requiring the user to keep track of every dimension taken, thus allowing for a human error.

### SUMMARY OF THE INVENTION

Therefore, a general object of the present invention is to improve the efficiency of field verifications of existing structures which utilize simple geometry as well as to improve the efficiency of field verifications of existing objects and building components such as doors, windows, walls, skylights etc, most of which also utilize simple geometry. In particular, the present invention aims to provide a device, a system, and a method that enables user to obtain basic dimensional and angular properties of an object such as length, width, height, area, volume as well as other information using a single measurement action or significantly reducing amount of measurement actions needed to obtain such information. In addition, the present invention aims to provide CADD software program functions which are capable of creating schematic drawings of the measured spaces, assigning object properties to measured and derived data, allowing for reproduction of architectural and other building elements in two-dimensional space and three-dimensional space easily and rapidly. In addition, the present invention aims to provide estimating software program functions which are capable of classifying derived and measurement data, assigning object properties to measured and derived data, allowing for assignment of price per unit variables and producing pricing and quantity take-off reports. In addition, the present invention aims to provide spreadsheet software interface functions which are capable of classifying derived and measurement data, assigning object properties to measured and derived data in a column layout and allowing for assignment of the measurement properties in a row format. Accordingly, known geometrical properties and relations between measured objects within two-dimensional and three-dimensional spaces needed to be utilized using set or programmed measuring algorithms.

According to the present invention, a measurement system, is provided comprising of a calculating processor that calculates both dimensional and angular values within measured space or a correspondence establishing processor that establishes a correspondence between distance calculating processor and an angle calculating processor and then calculates angular and dimensional values within measured space.

The calculating processor is to be used in a system which is equipped with both dimensional and angular data measurement capability.

The correspondence establishing processor is to be used in conjunction with a distance calculating processor and an angle calculating processor. Such setup may be used in a situation when a user wishes to add angular measurement device capability to an existing handheld laser-based measurement device.

Measurements are taken by a distance measuring device and angular measurement device which is capable of establishing angle measurement values between the line of sight of the distance measurement device and the axes of reference of the measured space. Measurements are transferred for further processing to the geometric processor.

A geometric processor superimposes a set of user-defined, programmed, known or assumed to be known angular and/or dimensional values for the purpose of establishing dimensional and/or angular values for the unknown points within measured space, whereas user is required to follow a set measurement algorithm or algorithms.

Measurement algorithm is programmed or user-defined which proposes a set of actions that user needs to perform in order to supply the geometric processor with correct geometrical information. When measurement algorithms are followed correctly by the user, geometric processor is able to calculate extensive list of geometrical properties within measured space, which saves user from obtaining additional dimensional measurements, allows user to perform distance measurements without having clear shortest direct line of sight, adjusts leveling inaccuracy of the measuring device and performs any other programmed function, based available geometrical assumptions with regard to the measured space.

According to the present invention, a measurement system in which certain properties may be prescribed to the derived and measured dimensional values automatically and or by the user. Such, for example, when user obtains rectangular shape using a specific measuring algorithm he or she may define such shape to have properties of a building element such as a door or a window, of which the measurement data was collected.

According to the present invention, an array of software including CADD systems, estimating systems and general database systems may have various options added which provides user with various o functions which utilize programmed measurement algorithms, let user create new measurement algorithm and let user modify properties of the existing algorithms for measuring specific situations.

According to the present invention, one-click buttons can be added to the measurement devices which may be used to indicate that the user is ready to use a particular measuring algorithm.

The present invention proposes a new system and a method for measurement of structures in which certain geometrical properties are known or assumed to be known. By utilizing known geometrical arrangements, measurement algorithms, distance measurement device and angle measurement device, system is able to fully utilize known geometry of the existing structures as well as to present gathered information in a consistent output that may be used by various applications for further use and development. Currently handheld devices are used in the field and are capable of obtaining dimensional values only. By adding an angle measurement device, current proposed method eliminates a need to obtain additional dimensional values and instead relies on the angular value of the deviation from Y-axis by the measurement device. Basic geometric principle used in this case is founded on the fact that there are three elements which are required to be obtained in any given triangle in order to determine the rest of the elements. Because of the standard geometry utilized in the modern structures, measuring algorithms may be used to take a full advantage of the known or assumed to be known values in the existing structures. Such information is particularly useful because of the fact that when a user selects a measurement algorithm, the geometric processor which evaluates all of the available geometrical relationships can automatically assign physical properties as in relation to the structure measured as height of a wall, area of the floor, area of the ceiling etc. Such information, for example, may be easily relayed into estimating software which uses such categorization to assign separate work tasks to each element of the structure, such as painting to walls and ceiling and carpeting to floors.

### BRIEF DESCRIPTION OF THE DRAWINGS

Referring now to the drawings in which like reference numbers represent corresponding parts throughout:

FIG. 01 illustrates a schematic representation of the measurement device.

FIG. 02 illustrates corner-to-corner measurement algorithm within two-dimensional space with known geometrical values.

FIG. 03 illustrates height-determination algorithm within two-dimensional space with known geometrical values.

FIG. 04 illustrates sway algorithm in horizontal space with known geometrical values.

FIG. 05 illustrates sway algorithm in vertical space with known geometrical values.

FIGS. 06-A & 06-B illustrate corner-to-corner measurement algorithm within three-dimensional space with known geometrical values.

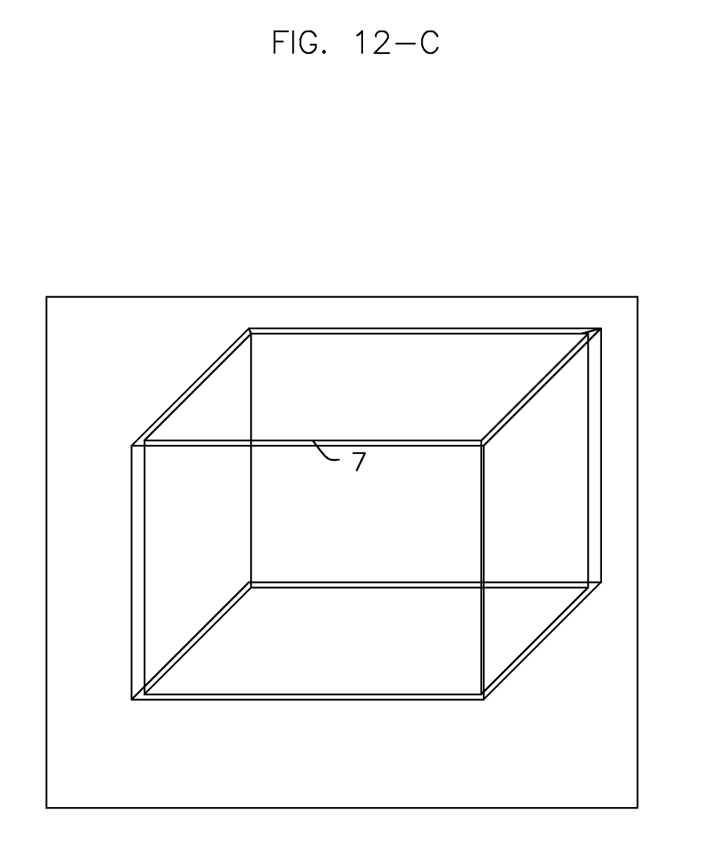

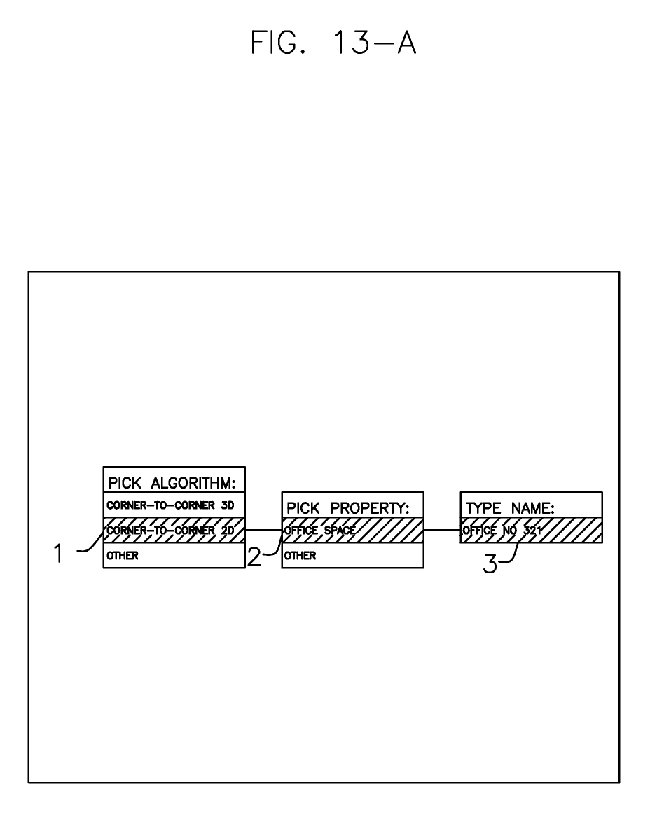

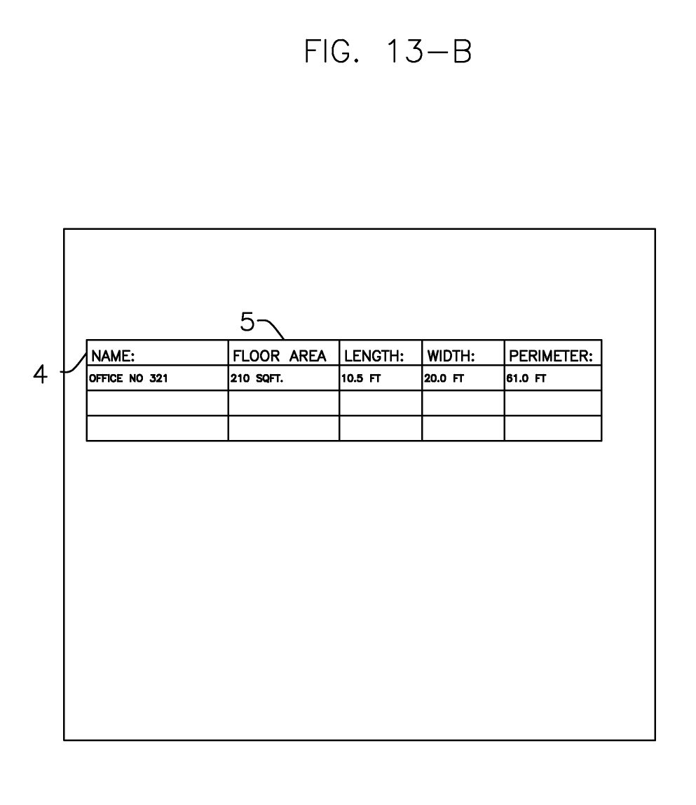

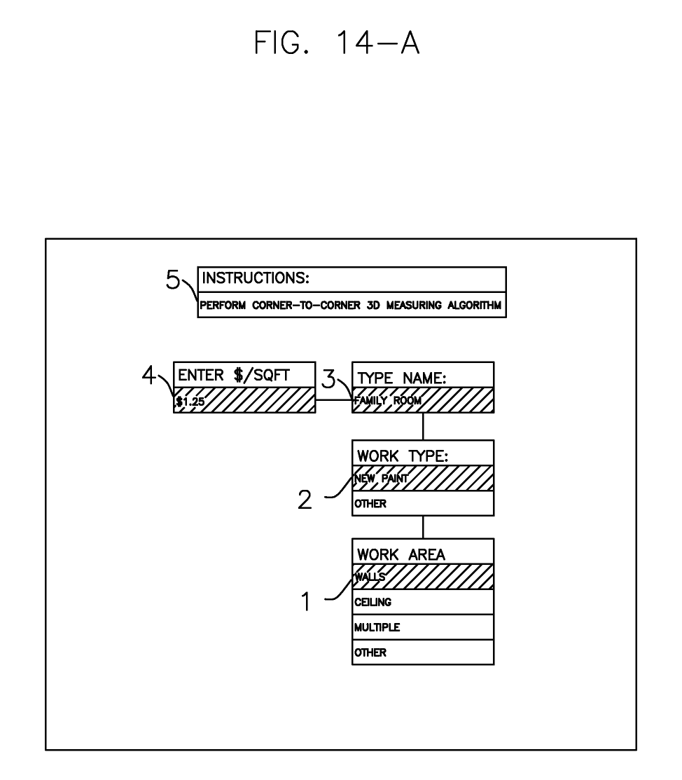

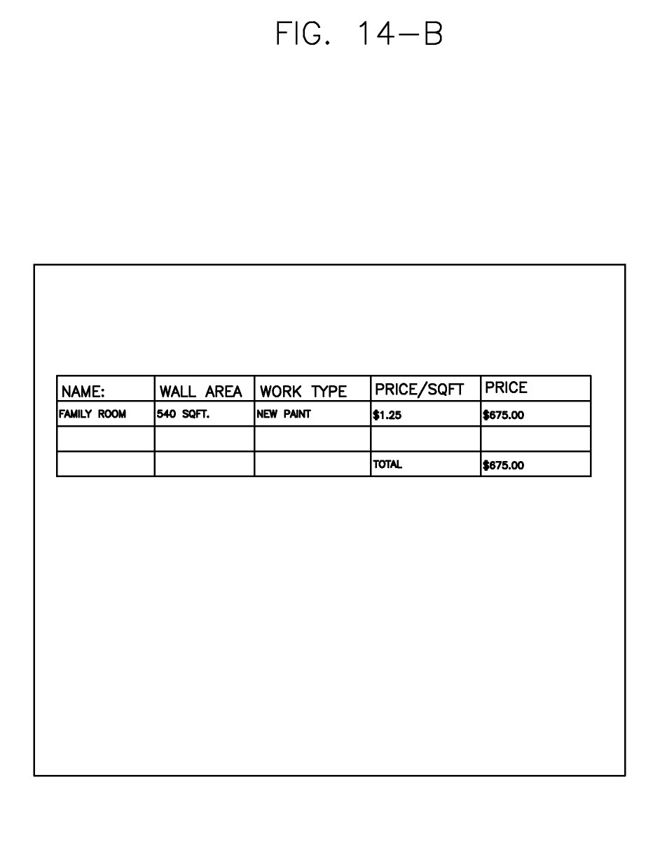

FIG. 05 illustrates possible one-click buttons which may be used to activate various measurement algorithm functions.

FIG. 08 illustrates schematic representation of the initial pointer in CADD software program.

FIGS. 09-A & 09-B illustrate an example of using corner-to-corner algorithm to create a wall layout of an existing office space in CADD software program.

FIGS. 10-A, 10-B & 10-C illustrate an example of using corner-to-corner algorithm to draw a wall in three-dimensional space in CADD software program.

FIGS. 11-A, 11-B, 1I-C & 11-D illustrate an example of using corner-to-corner algorithm to draw a window in three-dimensional space in CADD software program.

FIGS. 12-A, 12-B & 12-C illustrate an example of using corner-to-corner algorithm to draw an office space layout in three-dimensional space in CADD software program.

FIGS. 13-A & 13-B illustrate an example of using corner-to-corner algorithm to input values into a database.

FIGS. 14-A & 14-B illustrate an example of using corner-to-corner algorithm to create an estimate and a take-off report.

FIG. 15 is a flow diagram which illustrates three ways of creating a measurement algorithm compatible with the measurement system

FIG. 16 is a flow diagram which illustrates measurement data acquisition and analysis

FIG. 17 is a flow diagram which illustrates task flow of the case when the measurement algorithm function is used in conjunction with a CADD software program.

FIG. 18 is a flow diagram which illustrates task flow of the case when the measurement algorithm function is used in conjunction with an Estimating software program.

### DETAILED DESCRIPTION OF THE INVENTION

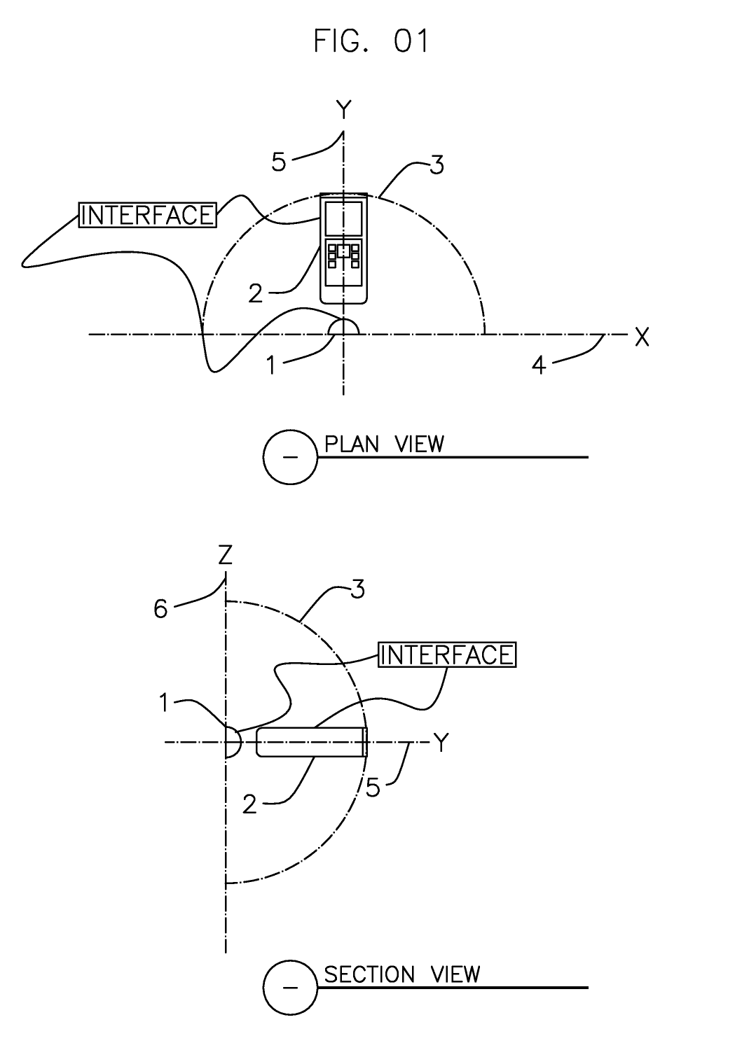

FIG. 01 The measurement system, according to the present invention comprises of a distance measurement device (Item 2), an angle measurement device (Item 1), interface between the two devices according to FIG. 01. Interface, according to the present invention may be built-in into the measurement device or be an external device such as PDA or a personal computer. Looking at the plan view of the FIG. 01 Items 4 and 5 represent horizontal axes X an Y. Various structural surfaces and physical elements intend to reside along the axis X, whereas axis Y represents an initial position of the line of sight of the distance measurement device. Item 3 shown on the FIG. 01 represents an angle at which the device may be rotated in reference to the axis X or axis Z. Item 6 shown on the FIG. 01 is the vertical Z axis which represents a vertical reference axes along the surface of the structure element from which measurements are to be taken. Basic principle of using the measurement device is based on its ability to deviate the distance measurement device away from Y axis by a known amount of degrees. Location of the origin for all of the axes is defined by a measuring algorithm which instructs the user, for example to place measurement device in the lower corner of the room. In this example, the Z axis is assigned to the line of the intersection of two walls, X axis is assigned to the line of intersection between a wall and a floor and the origin is assigned to the point of intersection of two walls and a floor.

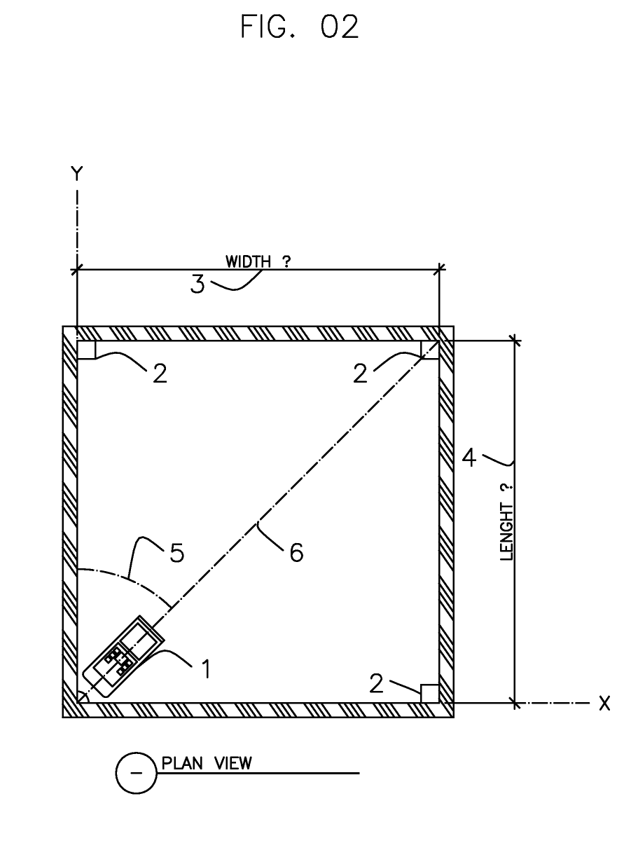

FIG. 02 represents a use of the measurement system (Item 1) in conjunction with a corner-to-corner measurement algorithm in two-dimensional space in which the position change along the vertical Z axis assume to remain zero. Such algorithm is useful when evaluating square or rectangular spaces. Angle measurement device in such case is needed to obtain only one angle—deviation of the measurement device from the Y axis, as designated by an Item 5. Items designated by an Item 2 are corners which are assumed to be ninety degrees. Width and length designated by the Items 3 and 4 are Width and Length of the measured space which are in question. The only length measured in this case is the Item 6, which is the diagonal value between opposite corners of the measured space. Measurement system is needed to obtain value for the Item 6 and Item 5 and in conjunction with the assumed geometrical properties of the space produces values for the width and length of the measured space. Values such as area and perimeter may be easily obtained using length and width as well. The usefulness of such algorithm is prescribed in the fact that the user is required to perform a single measurement task, instead of at obtaining length and width separately. Such algorithm may be used for measurement of other objects found in modern structures such as windows, openings, doors, and other elements which utilize simple square geometry. Also, due to the fact that the user is uses pre-defined algorithm length and width are define values, meaning that length and width values are always be assigned to the length and the width of the measured space, if the user follows algorithm properly. Such advantage becomes imperative in cases when the user needs to obtain such values as, for example, width and height of a window; in this example assigned value to the height always corresponds to the height in the field and the same is true for the width, if the algorithm is followed correctly.

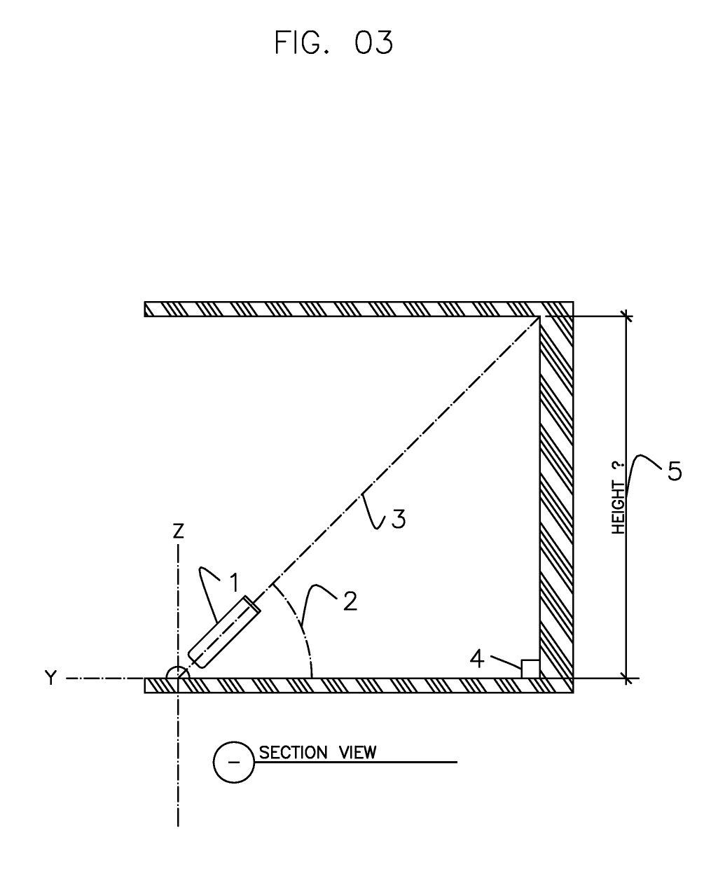

FIG. 03 represents a section view through a measured space within a structure. A height-determining algorithm set-up is to be used to determine a height of wall designated by the Item 5. A measurement system (Item 1) is positioned in this example at any point on the bottom of the floor. Item 4 designates a geometrical relationship between the wall and the floor, which in this particular case is assumed to be ninety degrees. Once the user activates height-determination algorithm, the measurement system establishes value for the measurement under Item 3 and a value for the deviation from the Y axis as angle represented as an Item 2. In this particular case, the user easily utilizes square geometry of the measured space in an effort to obtain a height of an object by performing a single measurement action instead of at least two dimensional measurements.

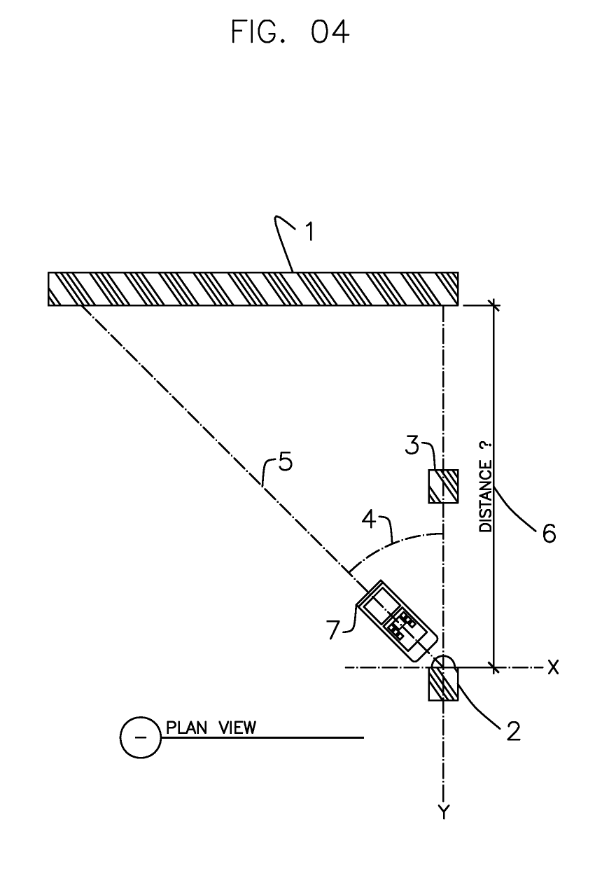

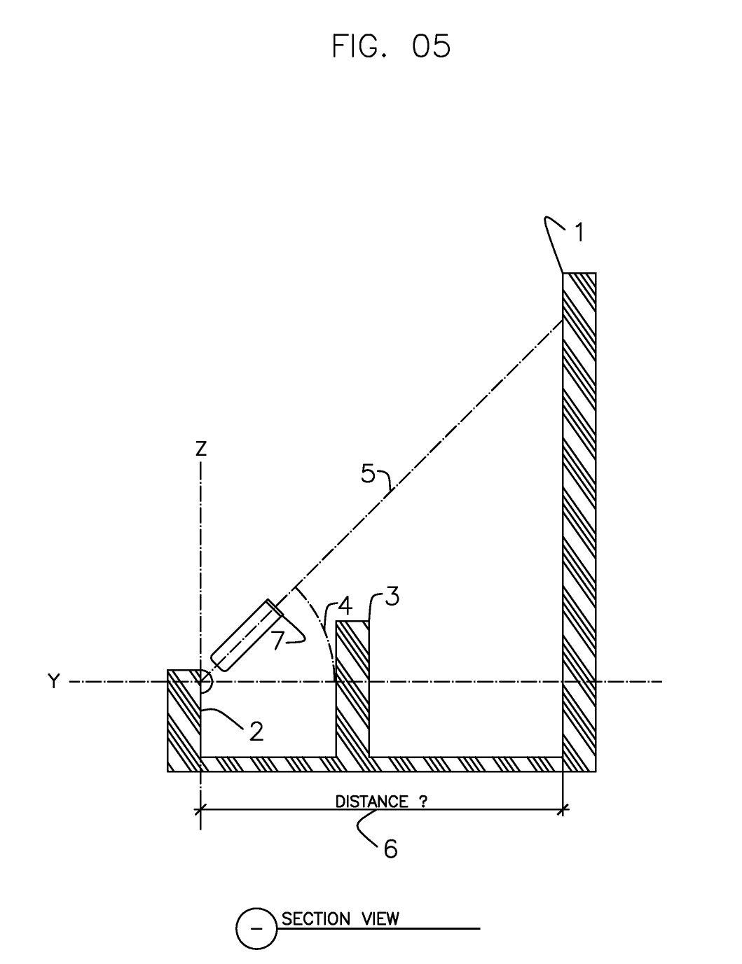

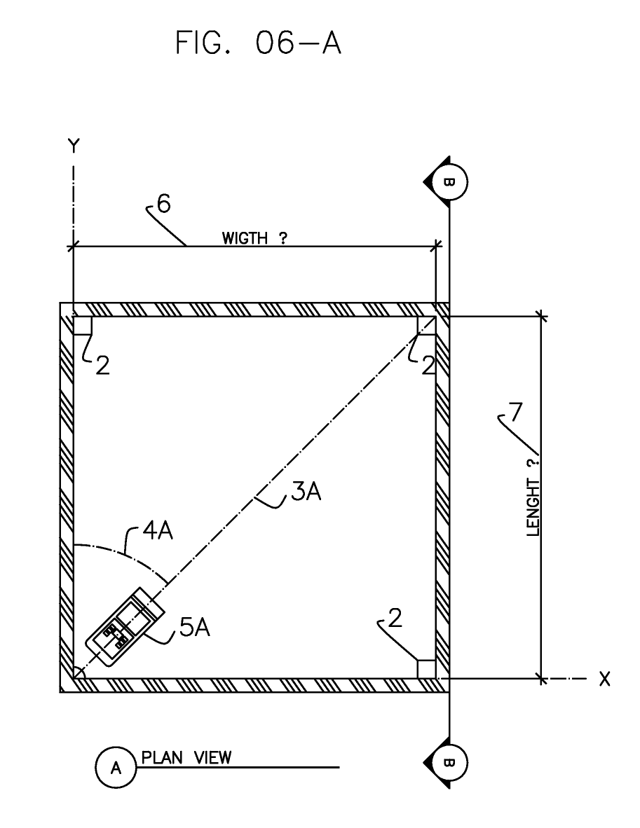

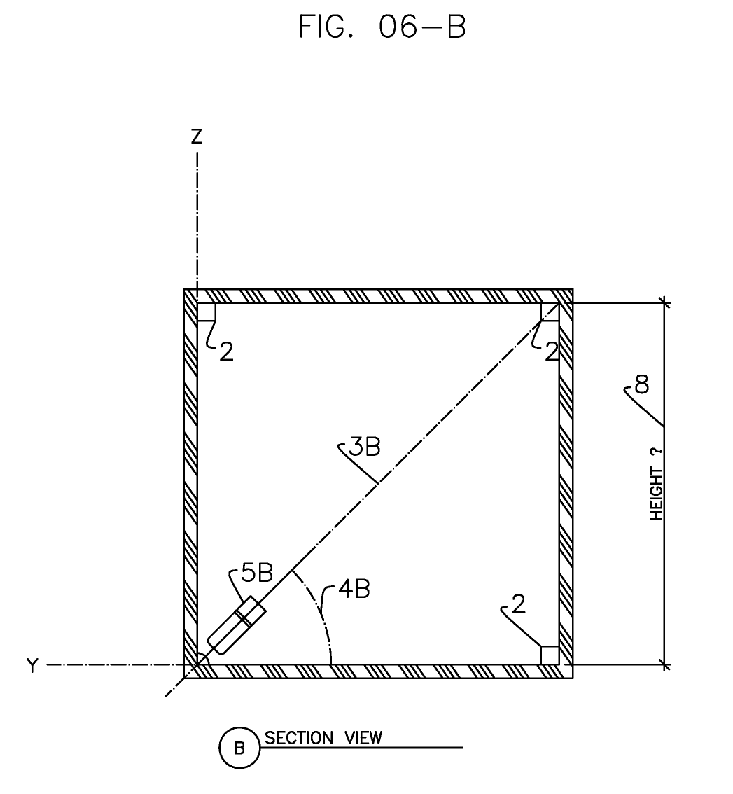

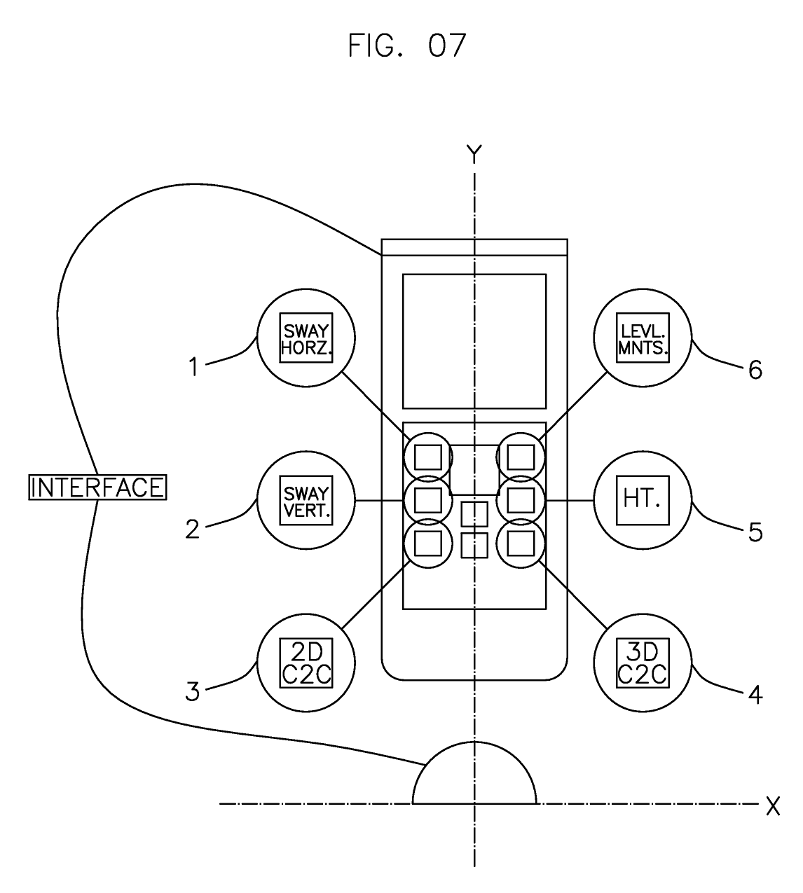

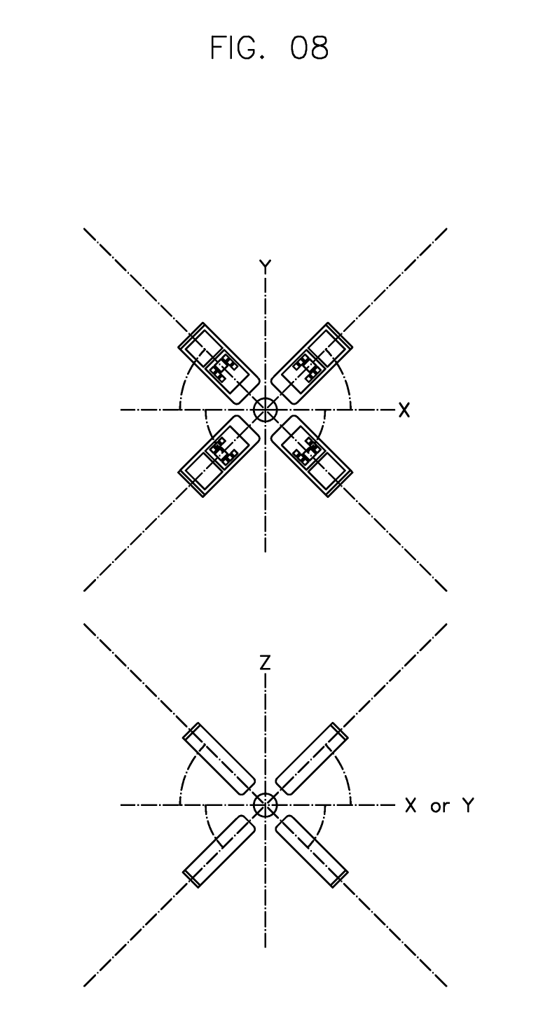

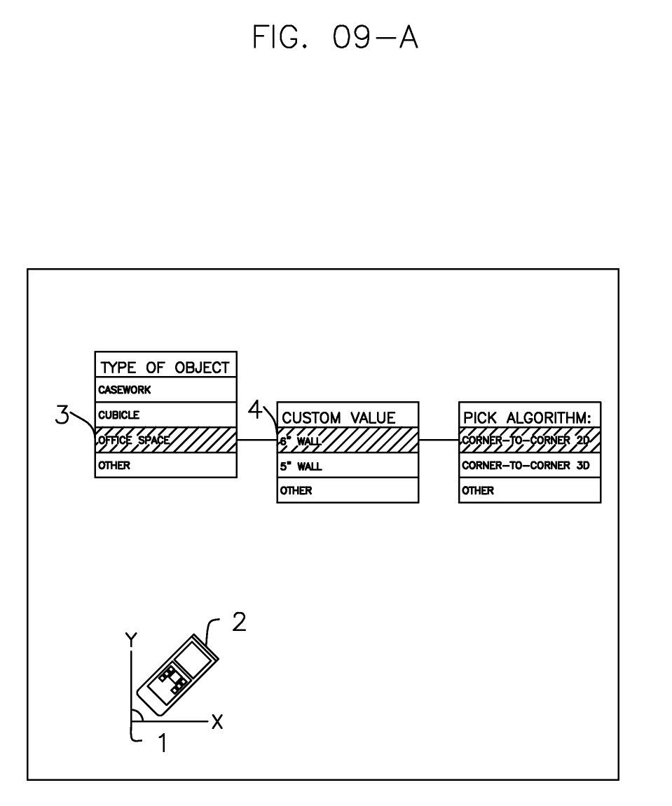

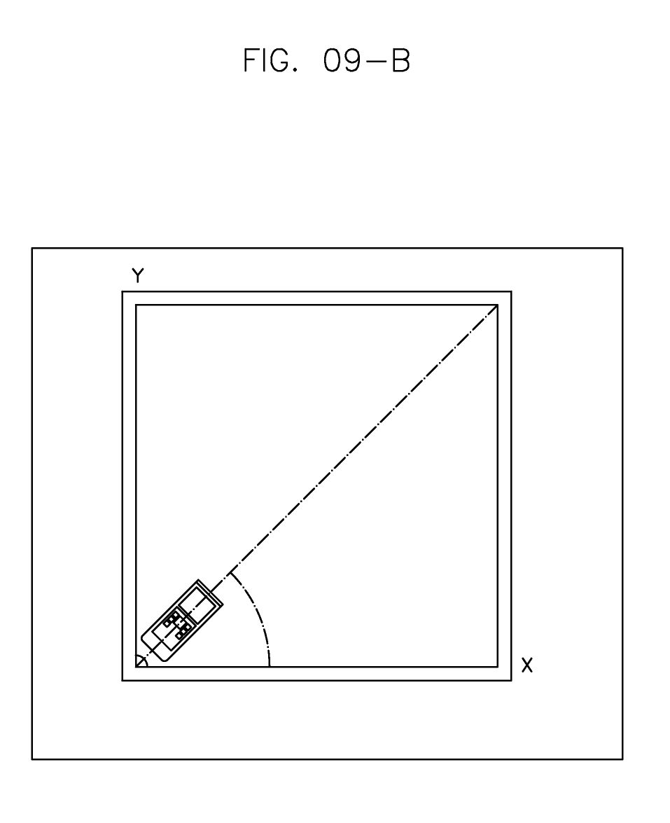

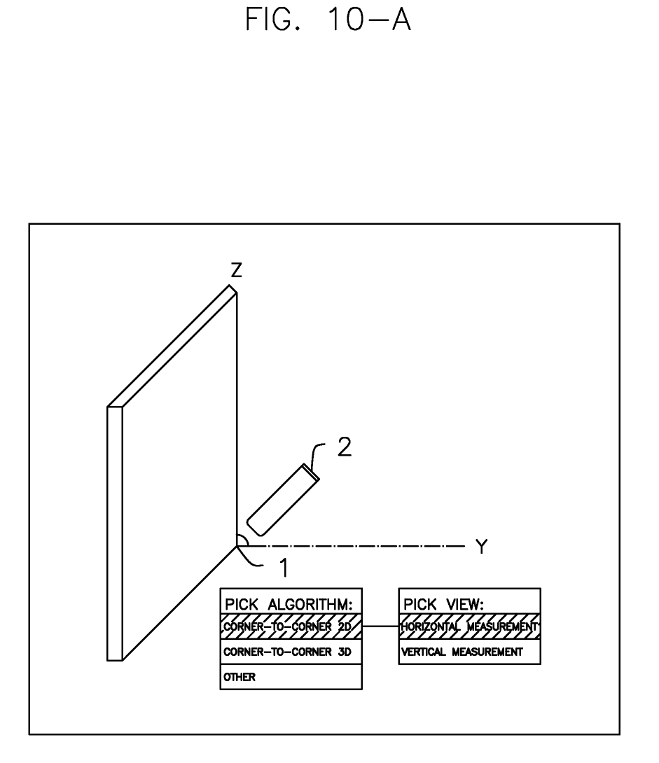

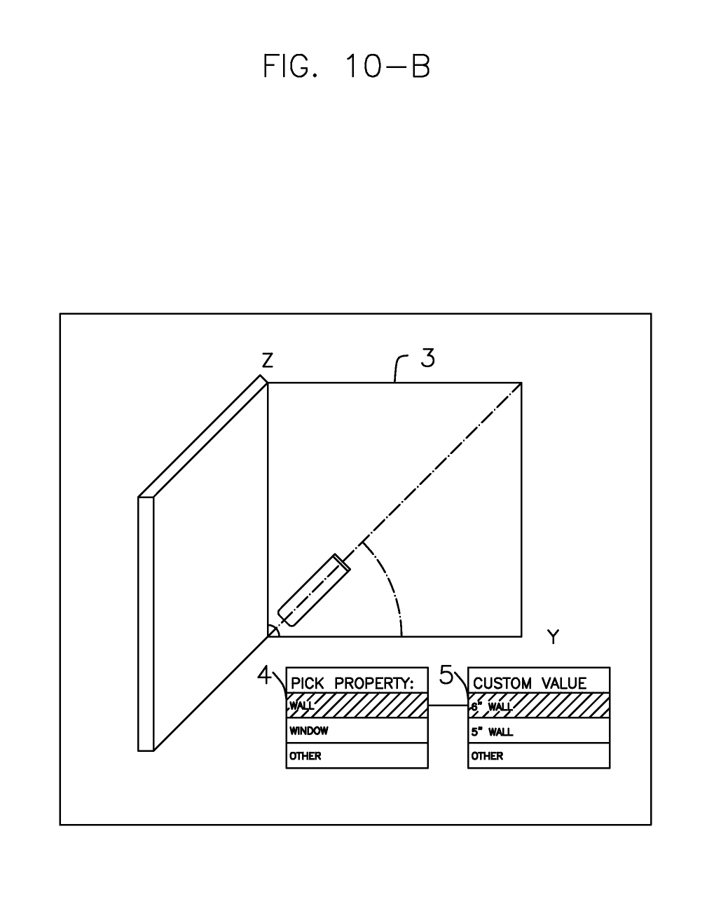

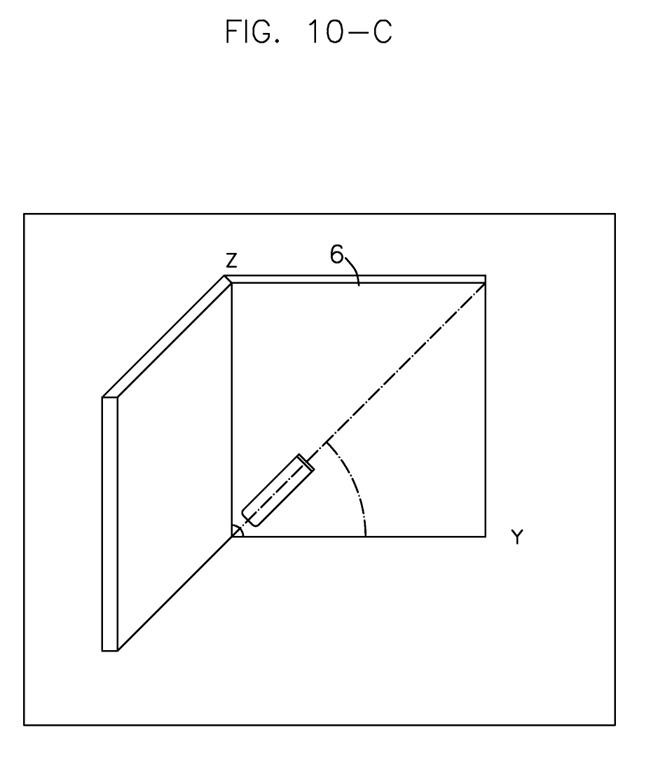

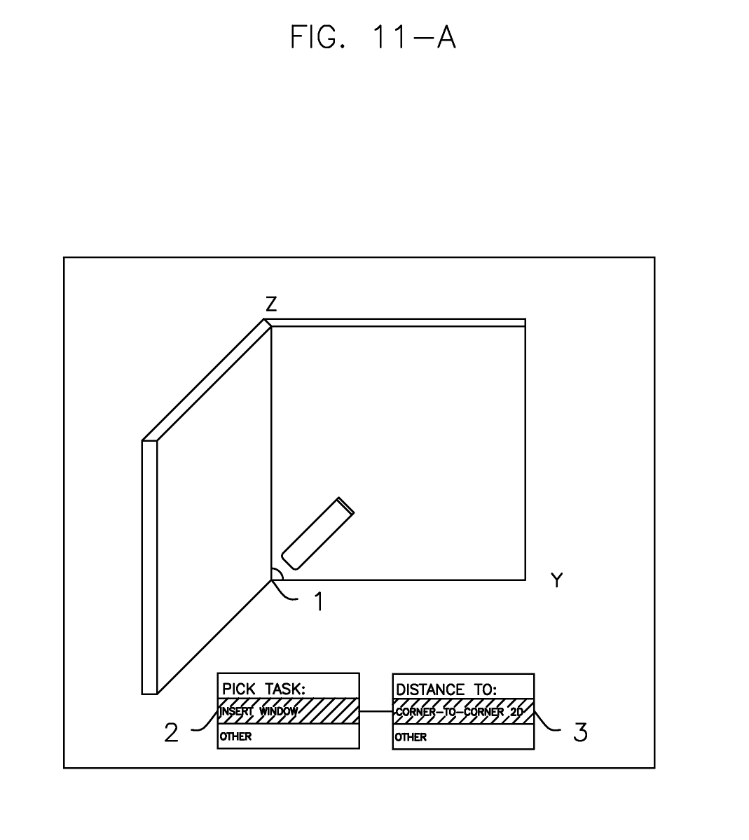

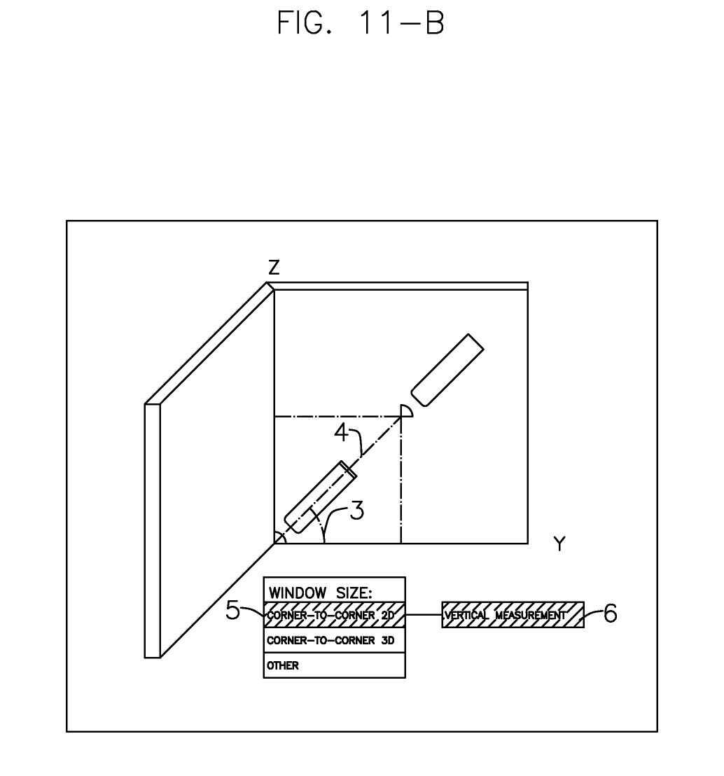

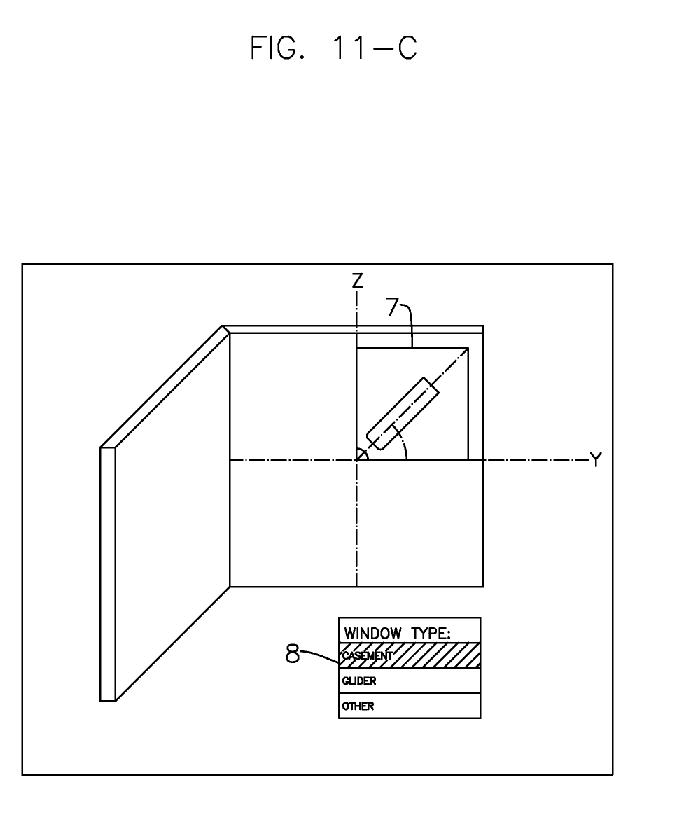

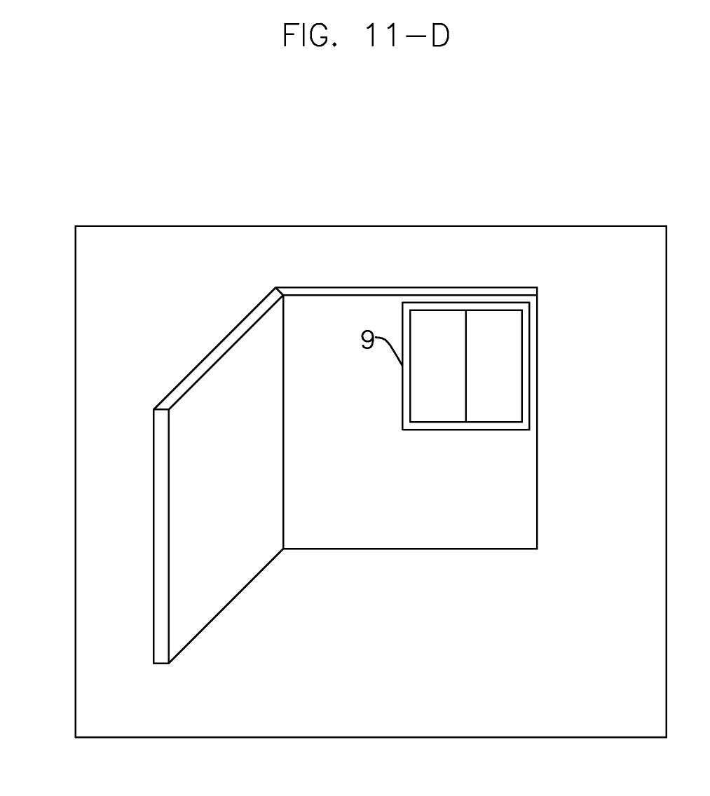

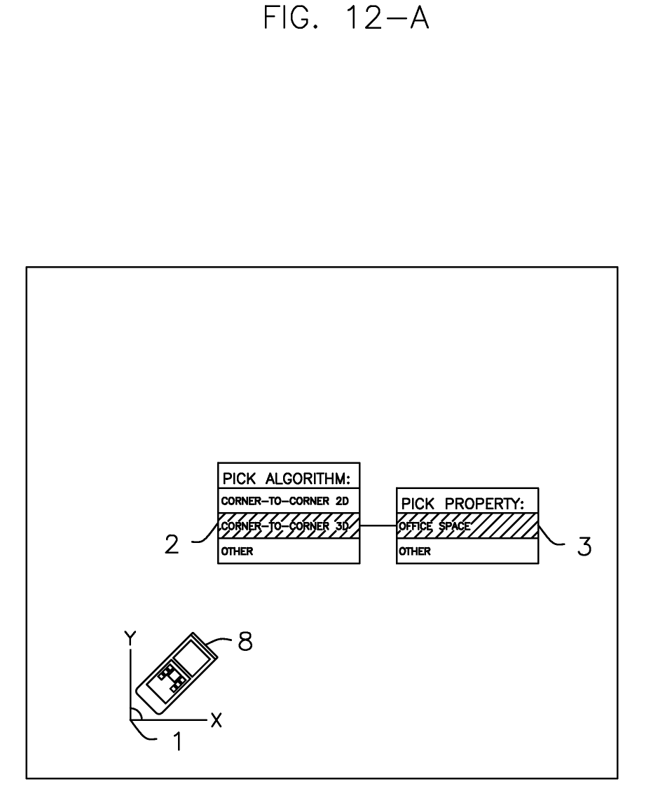

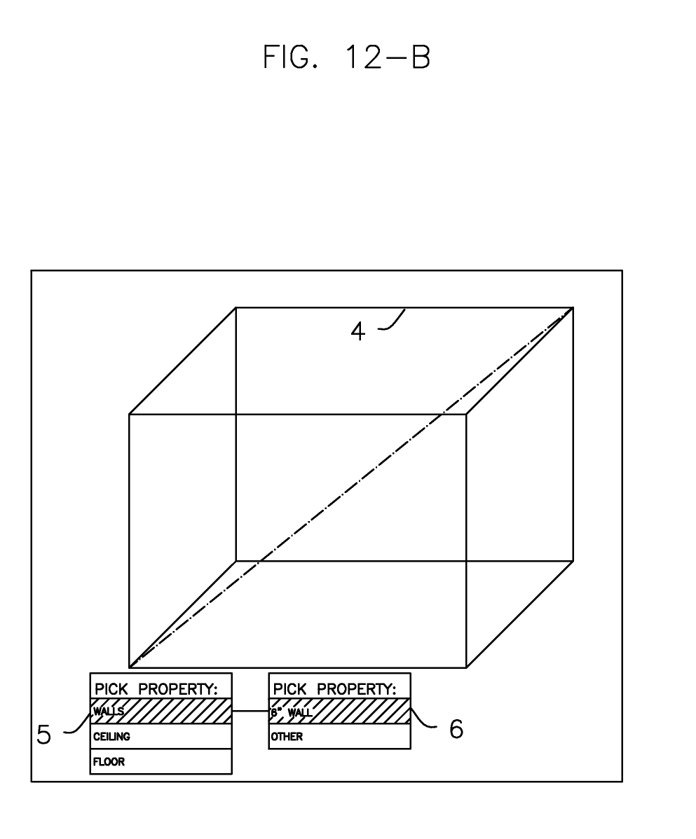

FIG. 04 represents a situation where a horizontal sway measurement algorithm may be used successfully to allow obtaining a distance value which may not measured accurately using a standard laser-based measurement device. The shortest line of sight (Item 6) between object designated as Item 1 and object designated as an Item 2 is obstructed by a third object designated by an Item 3. Sway algorithm, which user chooses in this case, allows user to sway measurement device (Item 7) and avoid object designated under Item 3, consequently taking a measurement (Item 5) between Item 1 and 2 which is not the shortest. Geometric processor, in its turn evaluates the shortest distance (Item 6) based on the assumption that the surface of the Item 1 is parallel to the surface of the Item 2 in conjunction with the angular value of the deviation from the Y-axis angle measurement (Item 4) and the distance measured (Item 5) calculates the shortest distance between Item 1 and 2 using trigonometric equations.

FIG. 05 represents a similar example, in which case user may use a vertical sway measurement algorithm in order to obtaining a distance value which may not measured accurately using a standard laser-based measurement device. The shortest line of sight (Item 6) between object designated as Item 1 and object designated as an Item 2 is obstructed by a third object designated by an Item 3. Vertical sway algorithm, which user chooses in this case, allows user to sway measurement device (Item 7) and avoid object designated under Item 3, consequently taking a measurement (Item 5) between Item 1 and 2 which is not the shortest. Geometric processor, in its turn evaluates the shortest distance (Item 6) based on the assumption that the surface of the Item 1 is parallel to the surface of the Item 2 in conjunction with the angular value of the deviation from the Y-axis angle measurement (Item 4) and the distance measured (Item 5) calculates the shortest distance between Item 1 and 2 using trigonometric equations.

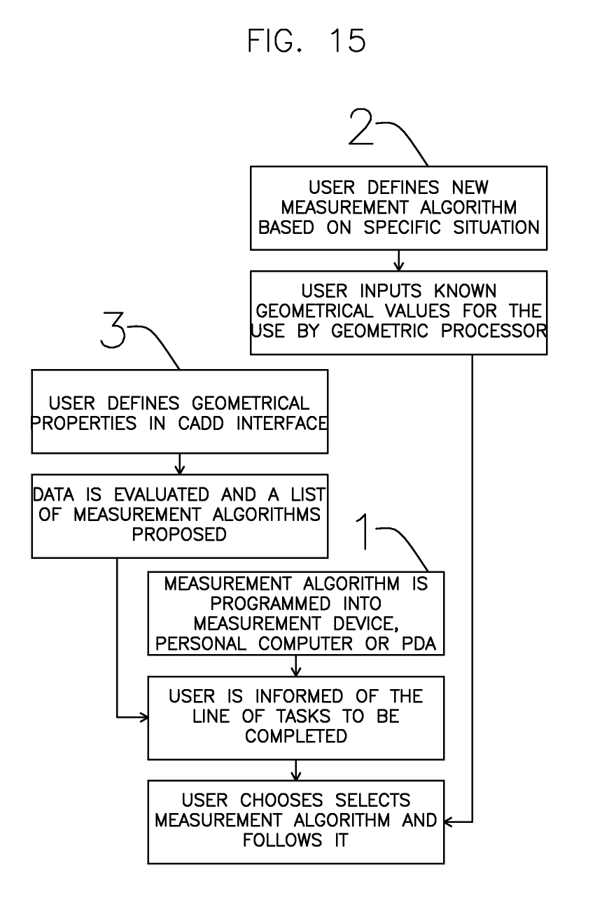

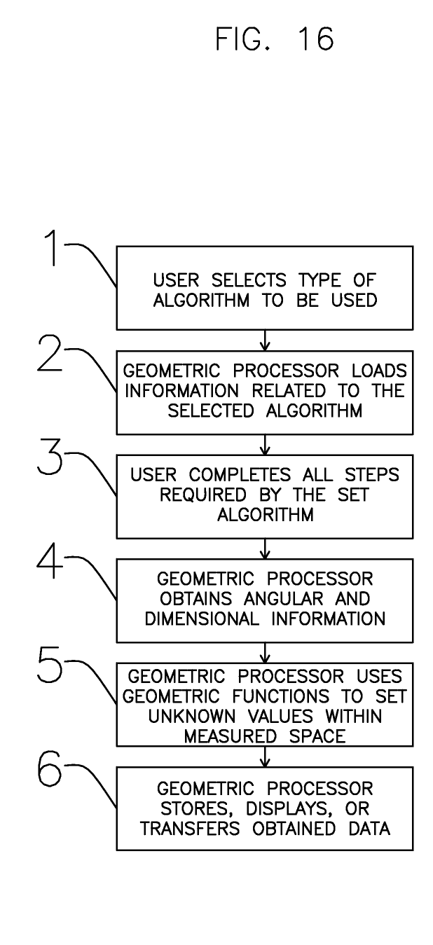

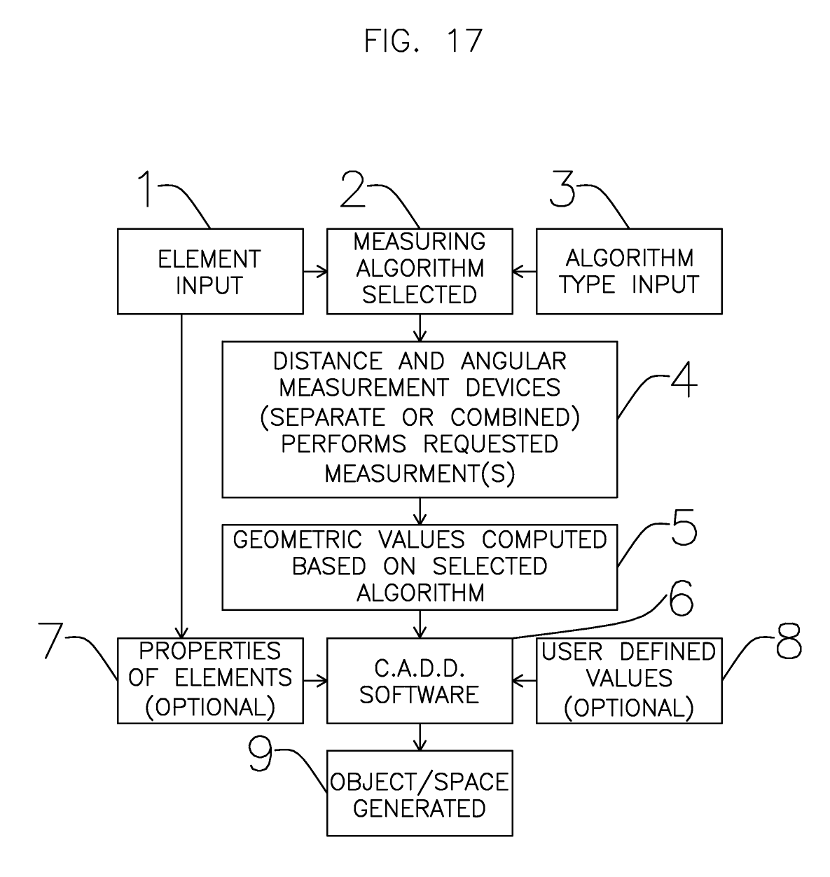

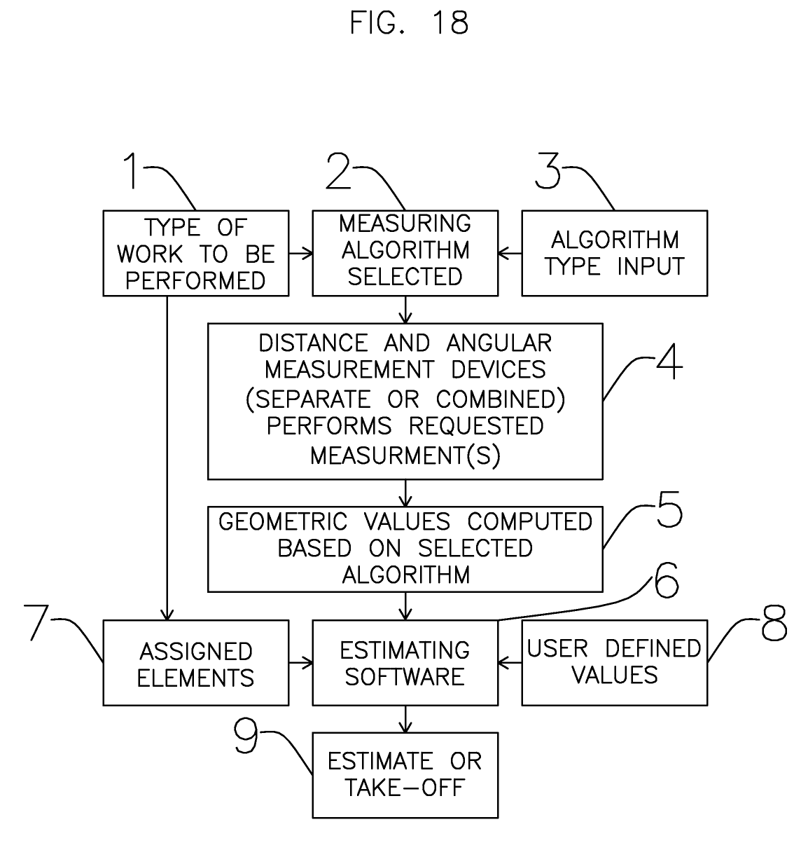

FIGS. 06-A & 06-B represent one of the most useful and efficient algorithms allowed under proposed measurement system. Corner-to-corner measurement algorithm is used in three-dimensional space in this case in which the measurement system (Items 5A and 5B) is used to obtain two deviating from the Y-axis angles—one in horizontal direction and another in vertical as shown by Items 4A and 4B. The user is taking a distance measurement (Items 3A and 3B) from a lower corner of the measured space into the upper diagonal corner of the same space. Items designated by an Item 2 are all corners which are assumed to be ninety degrees. Width, length and height of the measured space are in question and are designated by the Items 6, 7 and 8. The only length measured in this case is represented by Items 3A and 3B, which is the diagonal value between opposite corners of the measured space. Measurement system obtains value for the diagonal corner-to-corner distance and two deviations from the Y-axis angles and in conjunction with the assumed geometrical properties of the space produces values for the width, length and height of the measured space. Values such as area and perimeter, volume and others may be easily obtained using length and width as well. The usefulness of such algorithm is prescribed in the fact that the user is required to perform a single measurement task, instead of at obtaining length and width and height separately. Such algorithm may be used easily when, for example measuring a rectangular office space. Due to the fact that the user uses pre-defined algorithm, length, width and height are definite values, meaning that such values are automatically assigned to the length, width and the height of the measured space, if the user follows algorithm properly. Such advantage becomes imperative in cases when the user wishes to transfer data into a software program which is able to assign specific qualities to such elements as ceilings, walls, floors, etc. The user may, in this case, easily obtain area of all walls for paint estimating purposes in estimating software program, or the user may easily assign certain dimensional properties such as wall thickness in CADD software program to all measured walls.

FIG. 07 is a schematic list of various options that may be included within the measurement system that has angular and dimensional capacity built-in. Buttons represented are associated with various standard measurement algorithms which user may select as a single-click option. Item 1 represents an activation button for a Horizontal sway measurement algorithm used to avoid horizontal obstacles; Item 2 represents an activation button for a vertical sway measurement algorithm used to avoid vertical obstacles; Item 3 represents an activation button for a corner-to-corner measurement algorithm in two-dimensions used to obtain sq footage, perimeter and dimensions; Item 4 represents an activation button for a corner-to-corner measurement algorithm in three-dimensions used to obtain sq footage and dimensions, height, volume, area of the walls and perimeter; Item 5 represents an activation button for a vertical height measurement algorithm used whenever height determination of on object is needed; Item 6 represents an activation button for a automatic leveling adjustments made to the measurements based on the angular readings and is similar to the object avoidance algorithm. Activation methods of the algorithms listed may be in any other form besides buttons such as a selection menu. Activation buttons shown may be added to the measurement system in any combination or arrangement depending on the intended use of the measurement system and general practicality.

FIGS. 08 through 12 illustrate examples which illustrate direct application of the described algorithms to CADD software programs when using proposed measurement system within structures. CADD software is most likely be running on a personal computer or a PDA device which is connected to the measurement system. However, it also may be a built-in function capable of processing such data in graphical form quickly and rapidly. In order to take a full advantage of the proposed measurement system, an option described in FIG. 08 is a schematic depiction of the measurement system which is proposed to be built-in the origin point within the main screen of the CADD software program. Whenever the user is ready to use the measurement system in conjunction with a CADD software program, he or she first needs to define a starting point on the screen from which the dimensional and angular measurements are taken. The user then may use a pointing device to select a general direction of the measurement device by selecting one of the four quarters or a axes reference from which the angle is to be measured in reference to any existing objects that the user may already had drawn. Such option allows geometric processor accurately position and for CADD software to accurately draw measured and derived data. There may be an added option for acquiring general direction automatically whenever measurement device is equipped with an electronic compass and the CADD drawing has a North reference set against the North reference of the compass.

FIGS. 09-A & 09-B illustrate CADD screen example of the application of the measurement system and corner-to-corner algorithm in two-dimensions, whereas the user first defines the measurement starting point (Item 1), then chooses the general direction of the measurement in plan view (Item 2). User is then queried with a programmed menu which is illustrated on FIG. 09-A. Menu itself may be programmed in an array of options which may include any number of standard objects and definitions which is encountered in existing structures. In this case, because the user is using a plan-view, options shown propose objects that may be easily measured in plan view using any particular algorithm. In this example user selects item 3, which happens to be programmed value for an office space measurement. A custom set of values is activated which includes any number of programmed qualities in reference to the office space elements such as walls, ceilings, floors and other elements of the measured space. In this case, Item 4 is selected to indicate thickness of the measured walls. Once that is completed, a user is asked to select a programmed or a custom measurement algorithm which he or she intends to follow. User selects an algorithm which, in this case, requires user to obtain a measurement from an office corner to a diagonal corner, then performs such measurement. Geometric processor evaluates measurements taken in conjunction with set measurement algorithm assumed values and provides CADD software program with needed values to complete schematic wall layout as depicted in the FIG. 09-B. At this point the user may move on to perform other measurements as needed.

FIGS. 10-A, 10-B & 10-C illustrate CADD screen example of the application of the measurement system and corner-to-corner algorithm in a side-view application, whereas the user first defines the measurement starting point (Item 1), then chooses the general direction of the measurement in the side view (Item 2). User is then queried with a programmed menu which is illustrated on FIG. 10-A. In this example programmed requests user to select an algorithm first, illustrating the point that the selection menu may be organized in any number of ways which may be set by the user or the software manufacturer. The user then selects a corner-to-corner algorithm to be used. User takes actual measurements. Geometric processor evaluates measurements taken in conjunction with set of assumed values and provides CADD software program with needed values to complete schematic rectangle (Item 3). At this point the user may be satisfied with the result, or move on to apply properties to the rectangle which correspond to the type of measurement taken. In this example user had measured a diagonal corner-to-corner distance of a wall; thus, a customized menu, which may include any number of defined objects found in existing structures, allows user to set property to the drawn rectangle (Item 4). User is then asked to define any additional variable properties of the object selected, in this case being the width of the wall (Item 5). CADD software program then evaluates all given information and draws a schematic representation of a wall as shown by an Item 6, FIG. 10-C.

FIGS. 11-A, 11-B, 11-C & 11-D represent an example of another use of the measurement system in conjunction with a measurement algorithm within CADD software program. In this particular example, based on FIG. 11-A, user uses a side view to position and direct a starting point of measurement icon in the lower corner of the intersection of two sketched walls (Item 1) direction in this case is set automatic based on the fact that user selected a previously drawn wall to work with. CADD software program displays several programmed options which may be measured from such position. User selects a task (Item 2) which allows inserting a window element into the drawn wall. User then selects an algorithm to be used (Item 3) which is most useful in obtaining distance to the object which user wants to insert, in this case a window. FIG. 11-B represents a set-up in which the CADD software program had already obtained and recorded values for Items 3 and 4, giving a user a second initial measurement position to draw an object from. User selects a measurement algorithm (Item 5), this time to obtain a measurement values for the window itself confirming that he or she wishes to drawn an object vertically (Item 6). Once the measurement have been obtained, the CADD software program draws a rectangle (Item 7) in accordance to obtained measurement data. At this point, the user may choose any additional programmed qualifications which may be associated with a window object (Item 8). FIG. 11-D represents a view of a completed window (Item 9) as measured and recorded by the measurement system in conjunction with CADD software program.

FIGS. 12-A, 12-B & 12-C represent an example of using the measurement system in conjunction with a corner-to-corner measurement algorithm to create a three-dimensional representation of a rectangular office space using CADD software program. As in previous examples, user defines the starting point (FIG. 12-A, Item 1) and a general direction of the measurement is to be taken in (Item 8). Functional set-up, in this case as displayed in FIG. 12-A, lets user choose an algorithm (Item 2) first and then select an object type (Item 3) which may be measured with its help. In this case, user chooses to obtain measurements of an existing office space in three dimensions. After completing the measurement algorithm, the user ends up with a three-dimensional CADD representation of the interior measurements of the rectangular office space (FIG. 12-B, Item 4). Form this point, user uses programmed manus to select properties of any of the elements of the measured space such as wall type, ceiling type, floor type etc. In this case, user chooses to set-up wall settings (FIG. 12-B, Item 5) and then selects a custom property assigned to walls (FIG. 12-B, Item 6) which happens to be thickness of the wall. Based on the input data, CADD software program generates a three-dimensional model of the office space as depicted by an Item 7, FIG. 12-C.

FIGS. 13-A & 13-B. represents a practical example of the use of the measurement system in conjunction with a database which allows user to store and organize measurement data easily and efficiently. FIG. 13-A represents a selection menu, which inquires with regard to the type of the measurement algorithm user wishes to use (Item 1), the type of the measured space user is measuring (Item 2) and any additional information user wants to include such as the name of measured space (Item 3) for classification purposes. After all of the requested data is selected, user follows the selected algorithm. Because the values obtained by the measurement algorithm are definite, meaning that the height obtained may be directly associated with the height of the space, for example, database classification of the measured space is automatic. FIG. 13-B represents a column layout and a row layout. Row layout contains data with regard to the space name as defined by the user (Item 4). Column data (Item 5) may contain any information which can be obtained from the use of the measurement system and based on the particular measurement algorithm used. In this particular case selected measurement algorithm allows for following values to be obtained and classified: floor area, perimeter, length and width. Such reports may be used for a variety of purposes in construction, real estate, estimating and other related fields.

FIGS. 14-A & 14-B. represents a practical example of the use of the measurement system in conjunction with an estimating software program. FIG. 14-A represents a selection menu, which allows user to select various values and definitions easily and rapidly in field conditions. In the illustrated example user first selects work area (Item 1) which in this case are all walls of the measured space. A predefined or programmed work types (Item 2) are loaded by the estimating software program which, in this example, include painting of the selected walls. User then may enter the reference name (Item 3) which in this case is a “Family Room.” The final set (Item 4) allows user to enter a price per unit quantity which he or she wishes to apply to the particular work to be performed within the measured space. Based on the options user had selected, the estimating software proposes the best measuring algorithm to be performed (Item 5). Once the user performs requested actions by an Item 5, estimating software obtains needed information, assigns obtained values to the proper definitions, in this case area of the sides of the measured space to the area of all walls within “Family Room”, and presents an output (FIG. 14-B), in this case a table, which includes price value for the work to be performed within measured space. Such set-up is particularly useful to trades contractors which perform same type of work on daily basis. For example, a flooring contractor may obtain a pricing for the entire carpeting job while on site by taking a single measurement in all of the rooms which need carpet and multiplying the total obtained sq footage by the price per sq foot he or she is comfortable with. When using proposed measurement system in conjunction with the estimating software, in this example, the contractor is reducing possibility of a human error, as well as performing half of the measurements required.

FIG. 15 illustrates a diagram which depicts three ways of creating a measurement algorithm and inputting such algorithm into the measurement device, CADD software, estimating software or a database set-up. Option identified under Item 1 proposes a programmed algorithm, such as, for example, corner-to-corner algorithm, to be used, where the user informed of the actions to be performed and performs them accordingly. Another way for user to set-up a measurement algorithm is represented by an Item 2 which is to customize and existing algorithm by inputting custom values related to a specific site situation of the measured space, then follow the customized algorithm. Such method is valuable whenever user encounters a series of similar space which all have unusual geometrical relations or whenever user wishes to modify existing programmed algorithms to fit a particular situation he or she is facing at the time. Third option (Item 3) involves a creation of CADD interface where the user may assign certain geometrical properties to the existing objects drawn in CADD format. Such, for example, a schematic room layout may be drawn in plan view using four interconnected lines. Using specially programmed CADD interface, the user may assign each line a property of being perpendicular to the floor. Given such data, a number of possible measurement algorithms may be created by the geometric processor, any one of which user is invited to follow.

FIG. 16 represents a flow-chart explaining a flow process of tasks done by the user and measurement system's computerized components. Some tasks are interchangeable in their order and other may be automated. Item 1 represents user's tasks of selecting a measurement algorithm to be used. User has a wide array of options in terms of selecting an algorithm. Algorithm may be, for example, chosen automatically by the software interface based on the task that user had selected to perform; user may use a on-click buttons as shown in FIG. 07 or any other user-interface method applicable. Item 2 is the task of the geometric processor loading data which is associated with the measurement algorithm chosen by the user. Geometric processor may load such information at any time prior to the task designated by an Item 5. Item 3 of the flowchart requires user to actually perform a measurement algorithm tasks such that geometric processor can obtain measured data as proposed by an Item 4. Item 5 represents a vital task of the geometric processor evaluating assumed values as provided by the Item 2 and measured values as provided by an Item 4. Such data is evaluated using trigonometry and stored, displayed or transferred as needed (Item 6). Geometric processor may be built-in in either the measurement system or an external device such as a personal computer or PDA.

FIG. 17 represents a flow-chart explaining a flow process of tasks associated with using CADD interface in conjunction with the measuring system. Measurement algorithm (Item 2) in such set-up may be selected in two different ways. First method allows user to directly input the type of the algorithm to be used (Item 3). Another way allows user to choose an object which has a limited set of measuring algorithms assigned to it (Item 1). An example of an Item 1 input is a case when a user wishes to add a window, he or she chooses such function first, and CADD software program defines a list of algorithms which the user may perform to measure the window. User then performs the measurements using the measurement system (Item 4). Needed values are computed by the geometric processor (Item 5) and transferred to the CADD interface (Item 6). Geometric values may also be computed within CADD interface by the geometric processor. At this point CADD interface evaluates custom values (Item 8) defined by the user and any properties (Item 7) that may have been assigned to the drawn object. Such may be for example, user wishes to add a window which has 0.25 inch thick glass as a custom value and has a casement opening type as a property. Properties and custom values may also be assigned at the time when the user picks the type of the element to be created in Item 1. Item 9 represents a completed output such as the window which is completely drawn.

FIG. 18 represents a flow chart diagram which explains task process involved whenever the user is using estimating software in conjunction with the measurement system. As describe by an Item 1, the user has an option of selecting a work task which has an assigned optimal measuring algorithm (Item 2). User may also select measuring algorithm first without defining a programmed work task (Item 3). User then performs the measurements using the measurement system (Item 4). Needed values are computed by the geometric processor (Item 5) and transferred to the estimating interface (Item 6). Action by an Item 7 assigns elements whenever the user picks a work task. Such, for example, user selects work type as painting of the interior walls, a three-dimensional corner-to-corner algorithm is picked as an optimal by the software, user performs measurement algorithm and the area of the sides of the measured space is interpreted by the geometric processor and walls properties are automatically assigned to the sides of the measured space. Elements may also be assigned manually, in case when the user chooses to perform a measurement algorithm without specifying the type of work to be done per Item 3. Item 8 lets user input any values which identifies the space measured, provide per unit pricing, or any other information the user finds helpful during the estimating process. Given all of the input information, the estimating software is capable of generating an estimate report or a take-off report (Item 9).

1. A measurement system, comprising: distance/angle calculating processor that calculates both dimensional and angular values within measured space or a correspondence establishing processor that establishes a correspondence between distance calculating processor and an angle calculating processor and then calculates angular and dimensional values within measured space; a geometric processor that superimposes a set of user-defined, programmed, known or assumed to be known angular and/or dimensional values for the purpose of establishing dimensional and/or angular values for the unknown points within measured space, whereas user is required to follow definite measurement algorithm or algorithms.

2. A system according to claim 1, further comprising of a distance measuring device such as handheld laser distance measuring device that is able to obtain dimensional measurement information from the start point using straight line-of-sight to another point within measured space.

3. A system according to claim 1, further comprising of an angle measurement device of any design that is able to obtain angular measurement information in two-dimensional or three dimensional spaces in relation to one or more reference axes of the two-dimensional or three dimensional measured spaces and the line of sight of the distance measuring device.

4. A system according to claim 3, further comprising of an automatic, manual or any other accessible option which allows user to set a reference with one or more axes of the measured space.

5. A system according to claim 3, further comprising of an adjustment setting which calculates any disposition caused by the angular device to the distance measured by the distance measurement device.

6. A system according to claim 1, wherein measured space can be measured in two-dimensions or three dimension, depending on the data which user is interested in obtaining and is referred to any structure, any component of the structure, within or outside the structure irrelevant of the type, function or purpose.

7. A system according to claim 1, wherein dimensional and/or angular values which have been measured are recorded, stored, transferred, or displayed for the user, and wherein dimensional and/or angular values are organized in accordance with chosen measurement algorithm; wherein the measurement algorithms can be selected by the user before or after the measurements are done, automatically selected, applied in series when more than one measurement is taken, or in any other logical or practical combination.

8. A system according to claim 7, wherein a measurement algorithm of measuring at least one distance and at least one angular value allow user to obtain length, width, perimeter and an area of any rectangular or square measured two-dimensional space as an option which requires user to perform single measurement task which includes: indicating that user is ready to use the algorithm; setting of the measurement device at the starting point, being any corner of rectangular measured space; directing distance measurement device at the opposite diagonal corner parallel to the measured space; setting manually or allowing an automatic set of an angle between line of sight of the distance measurement device and one or more axes of rectangular or square space using angle measurement device; indicating that dimensional and angular values may be measured.

9. A system according to claim 8, wherein the user has an unlimited array of options of indicating which algorithm is to be used including, but not limited to: using a device which allows for a single algorithm to be used, using a device for which algorithms are programmed automatically, using a single-click button, selecting an algorithm from a menu, or any other user interface system or an automatic system capable of identifying the type of the algorithm to be used.

10. A system according to claim 8, wherein the order of the tasks performed by the user can be interchanged in any other logical or practical combination, some task elements may be automated as well as other task elements may be added for better accuracy.

11. A system according to claim 8, wherein the length, width, perimeter and an area are calculated using geometric processor that superimposes an assumption that the measured space is a square or a rectangle for the purpose of establishing dimensional and/or angular values for unknown points within measured space; wherein said all or some derived and measured dimensional and angular values are recorded, stored, transferred, or displayed for the user.

12. A system according to claim 7, wherein a measurement algorithm of measuring at least one distance and at least one angular value in two-dimensional space and at least two angular values in three-dimensional space allow user to obtain height of an object within structure or a height of the structure as an option which requires user to perform single measurement task which includes: indicating that user is ready to use the algorithm; setting of the measurement device at the starting point, being any surface positioned perpendicularly in line with the bottom of the structure or an object; directing distance measurement device toward the top of the structure or an object; setting manually or allowing an automatic set of an angle between line of sight of the distance measurement device and one or more axes of the perpendicular surface on which the device is set using angle measurement device; indicating that dimensional and angular values may be measured.

13. A system according to claim 12, wherein the user has an unlimited array of options of indicating which algorithm he or she is using including, but not limited to: using a device which allows for a single algorithm to be used, using a device for which algorithms are programmed automatically, using a single-click button, selecting an algorithm from a menu, or any other user-interface system or an automatic system capable of identifying the type of the algorithm to be used.

14. A system according to claim 12, wherein the order of the tasks can be interchanged in any other logical or practical combination, some task elements may be automated as well as other task elements may be added for accuracy.

15. A system according to claim 12, wherein, height of the measured space is calculated using geometric processor that superimposes an assumption that the object or structure stands perpendicular to the surface on which the measuring system is set for the purpose of establishing dimensional and/or angular values for the unknown points within measured space; wherein said all or some derived and measured dimensional and angular values are recorded, stored, transferred, or displayed for the user.

16. A system according to claim 12, wherein the algorithm may be used to determine the depth of an object if the system is positioned up-side-down.

17. A system according to claim 7, wherein a measurement algorithm of measuring at least one distance and at least one angular value in two-dimensional space and at least two angular values in three-dimensional space allow user to obtain shortest distance in two-dimensional or three-dimensional space between two parallel surfaces where direct line of sight of the shortest distance between two objects is blocked by another object as an option which requires user to perform single measurement task which includes: indicating that user is ready to use the algorithm; setting of the measurement device at the starting point, located on surface positioned in parallel to the measured surface; directing distance measurement device toward any point measured surface, except where the line of sight is blocked; setting manually or allowing an automatic set of an angle between line of sight of the distance measurement device and one or more axes of the parallel surface using angle measurement device; indicating that dimensional and angular values may be measured.

18. A system according to claim 17, wherein the user has an unlimited array of options of indicating which algorithm he or she is using including, but not limited to: using a device which allows for a single algorithm to be used, using a device for which algorithms are programmed automatically, using a single-click, selecting an algorithm from a menu, or any other user-interface system or an automatic system capable of identifying the type of the algorithm to be used.

19. A system according to claim 17, wherein the order of the tasks can be interchanged in any other logical or practical combination, some task elements may be automated as well as other task elements may be added for better accuracy.

20. A system according to claim 17, wherein the shortest line-of-sight distance is calculated using geometric processor that superimposes an assumption that the surface on which the starting point is located is parallel to the measurement surface for the purpose of establishing dimensional and/or angular values for the unknown points within measured space; wherein said all or some derived and measured dimensional and angular values are recorded, stored, transferred, or displayed for the user.

21. A system according to claim 17, wherein the algorithm may be used for other applicable measurement options, such as the case when two parallel surfaces are not located directly in front of one another.

22. A system according to claim 7, wherein a measurement algorithm of measuring at least one distance and at least two angular values along two different axes of reference allow user to obtain length, width, perimeter, area of all surfaces separate, joint or in combination, as well as the volume and height of any rectangular or square measured three-dimensional space as an option which requires user to perform single measurement task which includes: indicating that user is ready to use the algorithm; setting of the measurement device at the starting point, located in any lower or corner of the measured space; directing distance measurement device toward an opposite diagonal upper point of the measured space; setting manually or allowing an automatic set of at least two angles between line of sight of the distance measurement device and two or more axes of the measured space using angle measurement device; indicating that dimensional and angular values may be measured.

23. A system according to claim 22, wherein the user has an unlimited array of options of indicating which algorithm he or she is using including, but not limited to: using a device which allows for a single algorithm to be used, using a device for which algorithms are programmed automatically, using a single-click button, selecting an algorithm from a menu, or any other user-interface system or an automatic system capable of identifying the type of the algorithm to be used.

24. A system according to claim 22, wherein the order of the tasks can be interchanged in any other logical or practical combination, some task elements may be automated as well as other task elements may be added for better accuracy.

25. A system according to claim 22, wherein the length, width, perimeter, area of all surfaces separate, joint or in combination, as well as the volume and height are calculated using geometric processor that superimposes an assumption that the measured space is square or a rectangle in all dimensions for the purpose of establishing dimensional and/or angular values for the unknown points within measured space; wherein said all or some derived and measured dimensional and angular values are recorded, stored, transferred, or displayed for the user.

26. A system according to claim 1, wherein the measurement algorithms may be modified, used in combination with one another, as well as the measurement tasks can be added or automated to ensure added accuracy.

27. A system according to claim 1, or wherein angular and/or dimensional data for the measured points can be transferred to a personal computer or a handheld computer and dimensional and/or angular values for unknown point or unknown points are calculated by a personal computer processor or a handheld computer processor using trigonometric functions, and wherein said dimensional values are recorded, displayed for the user, or transferred for further use.

28. A system according to claim 27, wherein a personal computer or a handheld computer is running a computer aided design and drafting (CADD) computer program.

29. A system according to claim 28, wherein computer aided design and drafting computer program includes an optional function or a series of functions which allow user to define square and rectangular shapes in two-dimensional or three-dimensional space using diagonal corner-to-corner measurements and/or angular values between distance measurement device and the reference axes at the starting corner of the square or rectangular object which is measured.

30. A system according to claim 29, wherein computer aided design and drafting computer program includes an optional function or a series of functions which allow user to define square and rectangular objects with programmed properties of such elements as walls, doors, skylights windows and interior spaces and other elements with shapes based on square geometry or other known or assumed to be know geometric relationships in two-dimensional or three-dimensional space using diagonal corner-to-corner measurements and/or angular values between distance measurement device and the reference axes at the starting corner of the square or rectangular object which is measured.

31. A system according to claim 28, wherein computer aided design and drafting computer program includes optional function or a series of functions which allow user to set a reference location, an approximate reference direction of the distance measuring device as well as an axes from which angles are measured from on the screen as a reference point for use with any given measurement algorithm.

32. A system according to claim 31, wherein the approximate reference direction of the measuring device can optionally be set using an electronic compass automatically, whereas electronic compass resides as an optional feature within the measurement device and transfers deviation from the magnetic north data to geometric processor, such that geometric processor may determine a reference for angular measurements taken.

33. A system according to claim 32, wherein in order for the approximate reference direction to be set automatically, the user must establish a relationship between the plan north in his CADD drawing and the magnetic north recorded by the electronic compass within the measurement device.

34. A system according to claim 33, wherein computer aided design and drafting computer program has an option which enables rotation of the entire plan view in line with the approximate direction of the measurement device as recorded by the electronic compass.

35. A system according to claim 27, wherein a personal computer or a handheld computer is running quantity and price estimating software.

36. A system according to claim 35, wherein estimating software is capable of assigning, evaluating and processing data derived from the diagonal corner-to-corner measurements and/or angular values measurement algorithms such as length, width, height, perimeter, area and volume.

37. A system according to claim 36, wherein estimating software is capable of assigning programmed descriptive properties to derived dimensional data automatically or using user input.

38. A system according to claim 37, wherein estimating software is capable of assigning per unit pricing data to descriptive properties.

39. A system according to claim 33, wherein estimating software is capable of generating, saving and transferring pricing and take-off reports based on the pricing data and the derived measurement data with an assignment of the descriptive properties.

40. A system according to claim 27, wherein a personal computer or a handheld computer is running spreadsheet database software.

41. A system according to claim 40, wherein spreadsheet software is capable of assigning, evaluating and processing data derived from the diagonal corner-to-corner measurement algorithms such as length, width, height, perimeter, area and volume in a column and row format.

42. A system according to claim 41, wherein spreadsheet software is capable of assigning programmed descriptive properties to derived dimensional data automatically or using user input.

43. A system according to claim 42, wherein spreadsheet software is capable of generating, saving and transferring reports based on the derived measurement data with an assignment of the descriptive properties in column layout and the measured space name in accordance to the particular measurement taken in a row layout.

44. A system according to claim 27, wherein a personal computer or a handheld computer can have the measurement device and angle measurement device built-in as an option.

45. A system according to claim 1, wherein measurement system for structures in which some angular properties are known or assumed to be known is different in a way that some dimensional data may be substituted for angular data in two-dimensional or three-dimensional space and arranged with known or assumed to be known angular and/or dimensional properties of the structure, thus eliminating need for additional dimensional measurements.

45. A system according to claim 1, wherein measurement system for structures which can be modified by creating new measurement algorithms based on the specific situation

46. A system according to claim 1, wherein measurement system for structures in which existing measurement algorithms may be adjusted based on the specific situation

47. A system according to claim 1, wherein leveling adjustments can be automatically programmed to correct leveling errors of the measurements in two-dimensional or three-dimensional space based on standard set of known or assumed to be known angular properties within the structure.
